(19) United States
(12) Patent Application Publication
(10) Pub. No.: US 2025/0013124 A1
(43) Pub. Date: Jan. 9, 2025

(54) CAMERA ACTUATOR AND CAMERA MODULE

(71) Applicant: SAMSUNG ELECTRO-MECHANICS CO., LTD., Suwon-si (KR)

(72) Inventors: Sanghun HAN, Suwon-si (KR); Jaeman PARK, Suwon-si (KR)

(73) Assignee: SAMSUNG ELECTRO-MECHANICS CO., LTD., Suwon-si (KR)

(21) Appl. No.: 18/668,443

(22) Filed: May 20, 2024

(30) Foreign Application Priority Data
Jul. 7, 2023 (KR) 10-2023-0088427

(51) Int. Cl. G03B 13/36; G02B 27/64; H04N 23/54

(52) U.S. Cl. CPC G03B 13/36; G02B 27/646; H04N 23/54

(57) ABSTRACT

A camera actuator is provided. The camera actuator includes a first carrier configured to move in an optical axis direction; a second carrier disposed on the first carrier, and configured to move in a direction perpendicular to the optical axis direction; a damper that protrudes from a first surface of the first carrier that faces the second carrier; and a stopper that is disposed on a first surface of the second carrier to face the damper in the direction perpendicular to the optical axis direction, and configured to limit a movement of the second carrier in the direction perpendicular to the optical axis direction.

### CROSS-REFERENCE TO RELATED APPLICATIONS

This application claims the benefit under 35 USC § 119(a) of Korean Patent Application No. 10-2023-0088427 filed on Jul. 7, 2023, in the Korean Intellectual Property Office, the entire disclosure of which is incorporated herein by reference for all purposes.

### BACKGROUND

### 1. Field

The following description relates to a camera actuator and a camera module.

### 2. Description of the Background

Mobile electronic devices such as, but not limited to, a smartphone or a tablet personal computer (PC) are widely distributed. The mobile electronic device is being manufactured to have thin form factor to improve portability. Further, in view of the explosive growth of the personal media market, there has been a dramatic increase in the number of images that are captured with the mobile electronic devices.

However, unless special equipment is implemented when a user takes a photograph or an image with the smartphone, the taken image may chaotically shake due to the user's movement (e.g., a hand tremor or a walking or running motion), or an outline of a subject may fade in the example of a still image.

Various technologies are employed to correct handshaking. For example, the taken image may be post-processed using software, or the shaking may be corrected by moving a camera's lens or an image sensor. When the image is corrected through software, there is a problem in which the smartphone has a simple mechanical structure, but an angle of view is narrowed because a portion of the image is cut off during an image processing process. An optical image stabilization (OIS) method that corrects the shaking by moving the sensor or the lens, is structurally complex because the smartphone includes a driving actuator, but the optical image stabilization method has an advantage in the angle of view.

On the other hand, in order to correct a larger shaking, a range in which the lens or the sensor moves has to increase. For example, when a lens barrel moves in a direction perpendicular to an optical axis to correct the shaking of the camera, a degree to which the shaking is corrected increases as a distance that the lens barrel may move increases.

As a movable range of a movable body (e.g., the lens barrel) increases, an amount of impacts that occur when the movable body hits a fixed body (e.g., a case that accommodates the lens barrel) increases. This may cause a noise or a damage to an internal component of the camera. Therefore, a method that may alleviate the amount of impacts or the noise that increases as the movable range of the movable body increases is desired.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera actuator includes a first carrier configured to move in an optical axis direction; a second carrier, disposed on the first carrier, and configured to move in a direction perpendicular to the optical axis direction; a damper that protrudes from a first surface of the first carrier that faces the second carrier; and a stopper that is disposed on a first surface of the second carrier to face the damper in the direction perpendicular to the optical axis direction, and configured to limit a movement of the second carrier in the direction perpendicular to the optical axis direction.

A groove portion may be disposed at an edge of the second carrier, and the groove portion is configured to accommodate the damper.

The stopper may include one surface of an edge of the second carrier constituting the groove portion.

The stopper may be configured to have a shape that is complementary to a shape of an edge of the damper facing the stopper.

A width of the groove portion along the direction perpendicular to the optical axis direction may be greater than a width of the damper along the direction perpendicular to the optical axis direction.

The first carrier may have a second surface that faces the first surface of the first carrier in the optical axis direction, and the damper is configured to penetrate the second surface of the first carrier from the first surface of the first carrier to protrude from the second surface of the first carrier.

The damper may be disposed at one or more corner regions of the first carrier.

The stopper may be disposed at one or more corner regions of the second carrier.

Each of the damper and the stopper may be provided in plural numbers.

The actuator may further include a lens holder that accommodates a lens barrel, wherein the lens holder may be disposed on the second carrier.

The first carrier may have a plurality of first guide grooves on a side surface thereof, the second carrier may have a plurality of second guide grooves on a third surface of the second carrier facing the first carrier, and the actuator may further include a plurality of first rolling members respectively disposed in the plurality of first guide grooves and configured to move the first carrier in the optical axis direction, and a plurality of second rolling members respectively disposed in the plurality of second guide grooves and configured to move the second carrier in the direction perpendicular to the optical axis direction.

The second carrier may have a plurality of third guide grooves on a fourth surface of the second carrier that faces the third surface of the second carrier in the optical axis direction, and the actuator may further include a plurality of third rolling members respectively disposed in the plurality of third guide grooves, and configured to move the second carrier in the direction perpendicular to the optical axis direction.

The actuator may further include a magnet disposed on a side surface of the first carrier and configured to provide a driving force to the first carrier; and a coil disposed to face the magnet, and configured to provide a driving force to the first carrier.

In a general aspect, a camera module includes a lens barrel; a housing that accommodates the lens barrel; a first carrier configured to move in an optical axis direction; a first carrier configured to move in an optical axis direction; a damper that protrudes from a first surface of the first carrier that faces the second carrier; and a stopper that is disposed on a first surface of the second carrier to face the damper in the direction perpendicular to the optical axis direction, and configured to limit a movement of the second carrier in the direction perpendicular to the optical axis direction.

A groove portion may be disposed at an edge of the second carrier and the groove portion is configured to accommodate the damper.

The stopper may include one surface of an edge of the second carrier constituting the groove portion.

A width of the groove portion along the direction perpendicular to the optical axis direction may be greater than a width of the damper along the direction perpendicular to the optical axis direction.

The first carrier may have a second surface that faces the first surface of the first carrier in the optical axis direction, and the damper may be configured to penetrate the second surface of the first carrier from the first surface of the first carrier to protrude from the second surface of the first carrier.

The first carrier may have a plurality of first guide grooves on a side surface thereof, the second carrier may have a plurality of second guide grooves on a third surface of the second carrier facing the first carrier, and the camera module further includes a plurality of first rolling members respectively disposed in the plurality of first guide grooves and configured to move the first carrier in the optical axis direction, and a plurality of second rolling members respectively disposed in the plurality of second guide grooves and configured to move the second carrier in the direction perpendicular to the optical axis direction.

The second carrier may have a plurality of third guide grooves on a fourth surface of the second carrier that faces the third surface of the second carrier in the optical axis direction, and the camera module further includes a plurality of third rolling members respectively disposed in the plurality of third guide grooves and configured to move the second carrier in the direction perpendicular to the optical axis direction.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates an exploded perspective view schematically showing the example camera module, in accordance with one or more embodiments.

FIG. 3 illustrates a plan view of a first carrier, a second carrier, and a damper, in accordance with one or more embodiments.

FIG. 4 illustrates a plan view of the first carrier and the damper, in accordance with one or more embodiments.

FIG. 5 illustrates a plan view of the second carrier and the damper, in accordance with one or more embodiments.

FIG. 6 illustrates an exploded perspective view schematically showing an example camera module, in accordance with one or more embodiments.

FIG. 7 illustrates a plan view of a first carrier, a second carrier, and a damper, in accordance with one or more embodiments.

FIG. 8 illustrates a plan view of the first carrier and the damper, in accordance with one or more embodiments.

FIG. 9 illustrates a plan view of the second carrier and the damper, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Further, throughout the specification, the phrase “on a plane” means viewing a target portion from the top, and the phrase “on a cross-section” means viewing a cross-section formed by perpendicularly cutting a target portion from the side.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Hereinafter, a Z-axis direction may refer to an optical axis direction, an X-axis direction may refer to a direction perpendicular to the optical axis direction, and a Y-axis direction may refer to a direction perpendicular to the optical axis direction and the X-axis direction.

One or more examples may provide a camera actuator and a camera module that may reduce an impact or a noise due to collision between a movable body and a fixed body, and may limit a range of movement in a direction perpendicular to an optical axis when shaking is corrected.

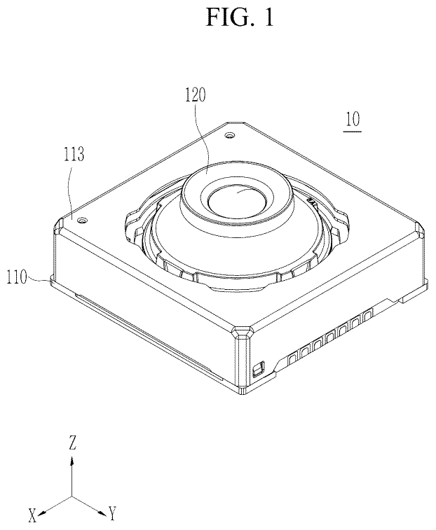

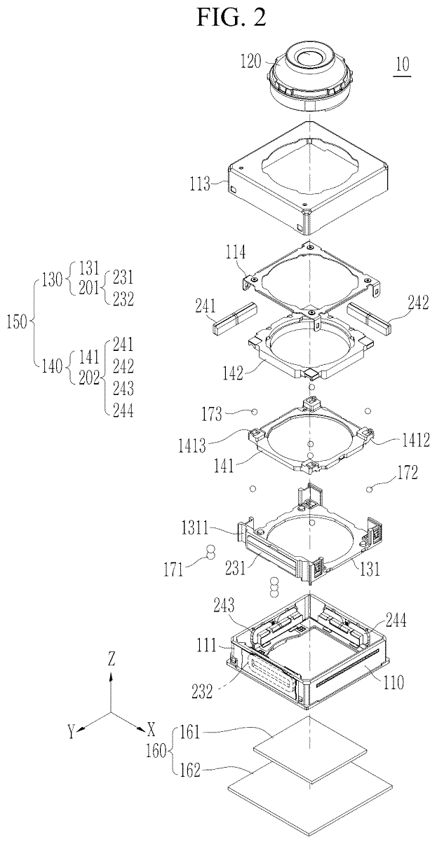

Hereinafter, an example camera module, in accordance with one or more embodiments, will be described with reference to FIGS. 1 and 2. FIG. 1 is a perspective view of the example camera module, in accordance with one or more embodiments, and FIG. 2 is an exploded perspective view schematically showing the camera module, in accordance with one or more embodiments.

Referring to FIGS. 1 and 2, the camera module 10, in accordance with one or more embodiments, may include a lens barrel 120, a lens driving device 150 that moves the lens barrel 120, an image sensor unit (or an image sensor portion) 160 that converts light incident through the lens barrel 120 to an electrical signal, a housing 110 that accommodates the lens barrel 120 and the lens driving device 150, and a cover 113.

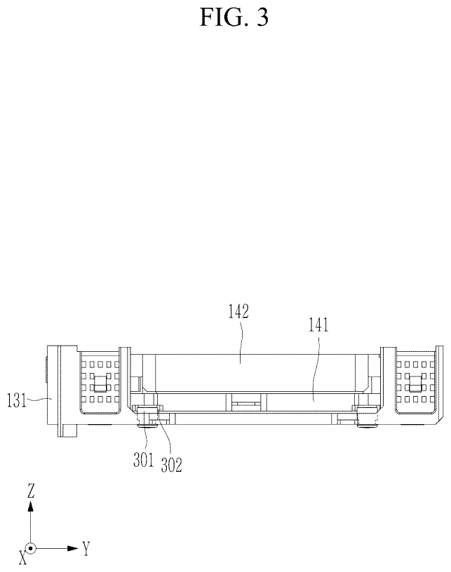

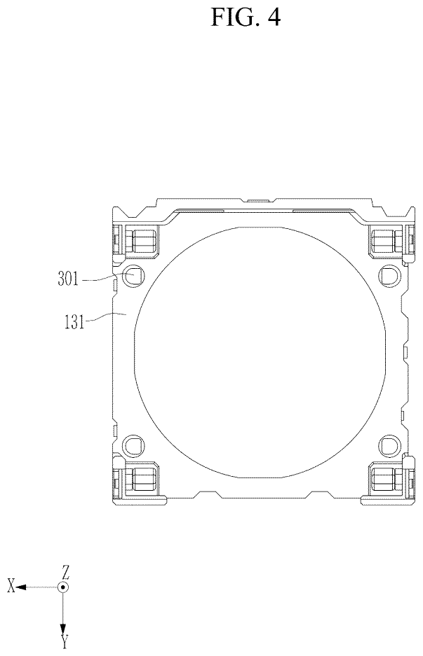

An actuator for a camera, in accordance with one or more embodiments, may include a first carrier 131 configured to move in the optical axis direction, a second carrier 141 disposed on the first carrier 131, and is configured to move in the direction perpendicular to the optical axis direction, a damper 301 (FIG. 4) that protrudes from a first surface of the first carrier 131 that faces the second carrier 141, and a stopper 302 (FIG. 3) that is disposed at one surface of the second carrier 141 to face the damper 301 in the direction perpendicular to the optical axis direction and is configured to limit movement of the second carrier 141 in the direction perpendicular to the optical axis direction.

The lens driving device 150 may be a device that moves the lens barrel 120, and may include a focus adjustment unit (or a focus adjustment portion) 130 that adjusts a focus, and a shaking correction unit (or a shaking correction portion) 140 that corrects a shaking.

The lens barrel 120 may be accommodated in a lens holder 142 to be accommodated in the focus adjustment portion 130 together with the second carrier 141.

The focus adjustment portion 130 may include the first carrier 131 that accommodates the lens barrel 120 and a first lens driving portion 201 that generates a driving force to move the lens barrel 120 and the first carrier 131 in the optical axis direction.

The first lens driving portion 201 may include a first magnet 231 and a first coil 232. The first magnet 231 of the first lens driving portion 201 may be disposed to be mounted on one surface of the first carrier 131, and the first coil 232 may be disposed within a substrate (or a board) 111 to face the first magnet 231 so that it is mounted at the housing 110.

The first magnet 231 and the first coil 232 may provide a driving force to the first carrier 131. When electrical power is applied to the first coil 232, the first carrier 131 may be moved in the optical axis direction based on electromagnetic influence between the first magnet 231 and the first coil 232. Since the lens barrel 120 is accommodated in the first carrier 131, the lens barrel 120 may also move in the optical axis direction by movement of the first carrier 131.

When the first carrier 131 is moved, a first rolling member 171 may be disposed between the first carrier 131 and the housing 110 to reduce friction between the first carrier 131 and the housing 110. A plurality of first rolling members 171 may have a ball shape, and may be disposed at both sides of the first magnet 231. The first carrier 131 may have a plurality of first guide grooves 1311 on one surface (for example, a side surface) thereof. The plurality of first rolling members 171 may be respectively disposed in the plurality of first guide grooves 1311. The plurality of first rolling members 171 may be accommodated in the plurality of first guide grooves 1311 to be guided in the optical axis direction. In other words, the plurality of first rolling members 171 may be configured to move the first carrier 131 in the optical axis direction.

The shaking correction portion 140 may include the second carrier 141 disposed on the first carrier 131 and which guides movement of the lens barrel 120, and a second lens driving portion 202 that generates a driving force to move the second carrier 141 in the direction perpendicular to the optical axis direction.

The second carrier 141 and the lens holder 142 may be inserted into the first carrier 131 to be disposed in the optical axis direction, and may guide the movement of the lens barrel 120. The lens holder 142 may be disposed on the second carrier 141.

The lens holder 142 may have an approximately quadrangle frame shape. Second magnets 241 and 242, which provide a driving force to the lens holder 142, may be disposed above or on the second carrier 141. Specifically, the plurality of second magnets 241 and 242 may be disposed on two adjacent surfaces of the second carrier 141. A cover member 114 may be further disposed at an upper portion of the lens barrel 120 to prevent the lens holder 142 from being separated from an internal space of the first carrier 131. The cover member 114 may be coupled to the first carrier 131.

The second lens driving portion 202 may include the second magnets 241 and 242 and second coils 243 and 244. The plurality of second magnets 241 and 242 of the second lens driving portion 202 may be mounted on the lens holder 142. The plurality of second coils 243 and 244 may be disposed at the substrate 111 to respectively face the plurality of second magnets 241 and 242 so that they are fixedly mounted on the housing 110.

A plurality of second rolling members 172 and a plurality of third rolling members 173 may be provided to support the shaking correction portion 140, and the plurality of second rolling members 172 and the plurality of third rolling members 173 may operate to guide the lens holder 142 during a shaking correction process. For example, the plurality of second rolling members 172 and the plurality of third rolling members 173 may be respectively disposed at a plurality of guide grooves disposed at both opposing surfaces of the second carrier 141 to move the second carrier 141 in the X-axis direction or the Y-axis direction.

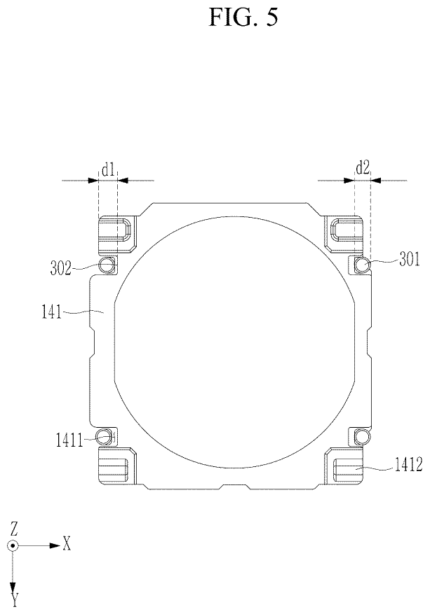

As a specific example, the second carrier 141 may have a plurality of second guide grooves 1412, as illustrated in FIGS. 2 and 5, or on a third surface facing the first carrier 131 in the optical axis direction. The plurality of second rolling members 172 may be respectively disposed in the plurality of second guide grooves 1412. The plurality of second rolling members 172 may be configured to move the second carrier 141 in the direction perpendicular to the optical axis direction. For example, the plurality of second rolling members 172 may be configured to move the second carrier 141 in a first direction that is either the X-axis direction or the Y-axis direction.

Additionally, the second carrier 141 may have a plurality of third guide grooves 1413 above or on a fourth surface facing the third surface in the optical axis direction. The plurality of third rolling members 173 may be respectively disposed in the plurality of third guide grooves 1413. The plurality of third rolling members 173 may be configured to move the second carrier 141 in the direction perpendicular to the optical axis direction. For example, the plurality of third rolling members 173 may be configured to move the second carrier 141 in a second direction that is the remaining direction rather than the first direction among the X-axis direction and the Y-axis direction.

Additionally, the plurality of second rolling members 172 and the plurality of third rolling members 173 may also operate to maintain an interval between the first carrier 131 and the lens holder 142. The plurality of second rolling members 172 may be disposed between the first carrier 131 and the second carrier 141. The plurality of third rolling members 173 may be disposed between the second carrier 141 and the lens holder 142.

The image sensor portion 160 is a device that converts light incident through the lens barrel 120 to the electrical signal. For example, the image sensor portion 160 may include an image sensor 161 and a printed circuit board 162 connected to the image sensor 161, and may further include an infrared filter. The infrared filter may block light in an infrared region among light incident through the lens barrel 120.

The image sensor 161 may convert light incident through the lens barrel 120 to an electrical signal. In a non-limited example, the image sensor 161 may be a charge-coupled device (CCD) or a complementary metal-oxide semiconductor (CMOS). The electrical signal converted by the image sensor 161 may be output as an image through a display device of a portable electronic device. The image sensor 161 may be fixed to the printed circuit board 162, and may be electrically connected to the printed circuit board 162.

The lens barrel 120 and the lens driving device 150 may be accommodated in an inner space of the housing 110, and in an example, the housing 110 may have a box shape in which upper and lower portions are opened. The image sensor portion 160 may be disposed at a lower portion of the housing 110.

The cover 113 may be coupled to the housing 110 to cover an outer surface of the housing 110, and may operate to protect an internal part of the camera module. Additionally, the cover 113 may operate to shield electromagnetic waves. In an example, the cover 113 may shield the electromagnetic waves so that the electromagnetic waves generated in the camera module do not affect other electronic components within the portable electronic device.

Additionally, since various electronic components other than the camera module may be mounted at the portable electronic device, the cover 113 may shield the electromagnetic wave so that the electromagnetic waves generated in the electronic components do not affect the camera module. In an example, the cover 113 may be made of a metal material to be grounded to a ground pad provided at the printed circuit board 162 so that the electromagnetic wave is shielded.

The first coil 232 of the first lens driving portion 201 and the plurality of second coils 243 and 244 of the second lens driving portion 202 may be buried within the substrate 111 so that the first coil 232 of the first lens driving portion 201 and the plurality of second coils 243 and 244 of the second lens driving portion 202 are formed as their own components of the substrate 111. Additionally, the first coil 232 of the first lens driving portion 201 and the plurality of second coils 243 and 244 of the second lens driving portion 202 may be buried together within one substrate 111.

Additionally, each of the first lens driving portion 201 and the second lens driving portion 202 may further include a sensing portion that senses (or detects) movement of the lens barrel 120, and the sensing portions of the first lens driving portion 201 and the second lens driving portion 202 may have an IC package form that may be controlled by a control unit (or a control portion) included in the printed circuit board 162 connected to the image sensor 161.

Hereinafter, the first carrier 131, the second carrier 141, the damper 301, and the stopper 302 will be described in more detail with reference to FIGS. 3 to 5. FIG. 3 is a plan view illustrating the first carrier, the second carrier, and the damper, FIG. 4 is a plan view of the first carrier and the damper according to an embodiment, and FIG. 5 is a plan view of the second carrier and the damper according to an embodiment. FIG. 4 is a plan view illustrating an inner bottom surface of the first carrier 131 at which the damper 301 is disposed, and FIG. 5 is a plan view illustrating a bottom surface of the second carrier 141 at which the damper 301 is disposed to show a relationship between the second carrier 141 and the damper 301.

Referring to FIG. 3 and FIG. 4, the damper 301 may be disposed on one surface of the first carrier 131. The damper 301 may be disposed between the first carrier 131 and the second carrier 141. The damper 301 may protrude in the optical axis direction from the first surface of the first carrier 131 facing the second carrier 141. Accordingly, when the first carrier 131 is moved in the direction perpendicular to the optical axis direction, an impact or a noise between the first carrier 131 and the second carrier 141 may be reduced.

The damper 301 may be provided in plural numbers. The damper 301 may be disposed at a corner region (or corner regions) of the first carrier 131. For example, if the first surface of the first carrier 131 has an approximately quadrangle shape, the plurality of dampers 301 may be disposed at four corner regions of the first carrier 131, respectively. In an example, the damper 301 may have a shape such as an approximately circular pillar or an approximately polygonal pillar.

The first carrier 131 may have a second surface facing the first surface in the optical axis direction. The damper 301 may penetrate the second surface from the first surface to protrude from the second surface in the optical axis direction. The damper 301 may penetrate a portion of the first carrier 131 to extend from the first surface to the second surface. The first carrier 131 may have a through hole that is penetrated by the damper 301. A portion of the damper 301 may be disposed between the first carrier 131 and the housing 110. Accordingly, when the first carrier 131 is moved in the optical axis direction, an impact or a noise between the first carrier 131 and the housing 110 may be reduced.

The damper 301 may be made of a material that may be elastically deformed by an external force, and may absorb an impact or may reduce an impact force by being deformed when it hits another structure. In an example, the damper 301 may be made of a material such as, but not limited to, rubber, urethane, silicone, or the like.

Referring to FIG. 3 and FIG. 5, a groove portion 1411 that is disposed at an edge of the second carrier 141 and accommodates the damper 301, may be disposed. The groove portion 1411 may extend inward from an outer edge of the second carrier 141. The groove portion 1411 may extend from one surface of the second carrier 141 facing the first carrier 131 in the optical axis direction. The groove portion 1411 may be provided in plural numbers.

A length of the damper 301 protruding from the first surface in the optical axis direction may be less than a length of the groove portion 1411 along the optical axis direction. Therefore, even when the damper 301 is accommodated in the groove portion, the damper 301 may be moved along the direction perpendicular to the optical axis.

The stopper 302 may be disposed on the one surface of the second carrier 141 so as to face the damper 301 in the direction perpendicular to the optical axis direction. The stopper 302 may be configured to limit the movement of the second carrier 141 in the direction perpendicular to the optical axis direction. The stopper 302 may include one surface of an edge of the second carrier 141 constituting the groove portion 1411. The stopper 302 may be disposed to surround at least a portion of the damper 301. Accordingly, when the first carrier 131 is moved in the example of the shaking correction or the like, a movement range of the damper 301 accommodated in the groove portion 1411 may be limited by the stopper 302. In an example, when the first carrier 131 and the damper 301 are moved in the X-axis direction, the damper 301 may contact the stopper 302, and the movement range of the damper 301 may be limited.

The stopper 302 may be provided in plural numbers. The stopper 302 may be disposed at a corner region (or corner regions) of the second carrier 141. For example, if a plane perpendicular to the optical axis direction of the second carrier 141 has an approximately quadrangle shape, a plurality of stoppers 302 may be disposed at four corner regions of the second carrier 141, respectively.

The stopper 302 may have a quadrangle cross-sectional shape with a straight line or one edge open. The stopper 302 may have a shape that is complementary to a shape of an edge of the damper 301 facing the stopper 302. For example, the edge of the damper 301 facing the stopper 302 may have a straight-line shape, and an edge of the stopper 302 facing the damper 301 may have a straight-line shape that is complementary to a shape of the damper 301. However, the one or more examples are not limited thereto, and the edge of the stopper 302 facing the damper 301 may have any shape that may be complementarily coupled to a shape of the damper 301. Accordingly, when the damper 301 moves in the direction perpendicular to the optical axis direction, the damper 301 may be in contact with one edge of the stopper 302 so that a target movement range of the damper 301 may be more accurately implemented during the shaking correction.

In an example, a width of the groove portion 1411 along the direction perpendicular to the optical axis direction may be larger than a width of the damper 301 along the direction perpendicular to the optical axis direction. In an example, a width d1 of the groove portion 1411 along the X-axis direction may be larger than a width d2 of the damper 301 along the X-axis direction. Specifically, a minimum width of the groove portion 1411 along the X-axis direction may be larger than the width d2 of the damper 301 along the X-axis direction, so that the damper 301 may be disposed to be spaced apart from the stopper 302. Therefore, when the damper 301 is accommodated in the groove portion 1411 to be moved in the direction perpendicular to the optical axis direction, the damper 301 may be moved within a difference range between the width of the groove portion 1411 along the direction perpendicular to the optical axis direction and the width of the damper 301 along the direction perpendicular to the optical axis direction.

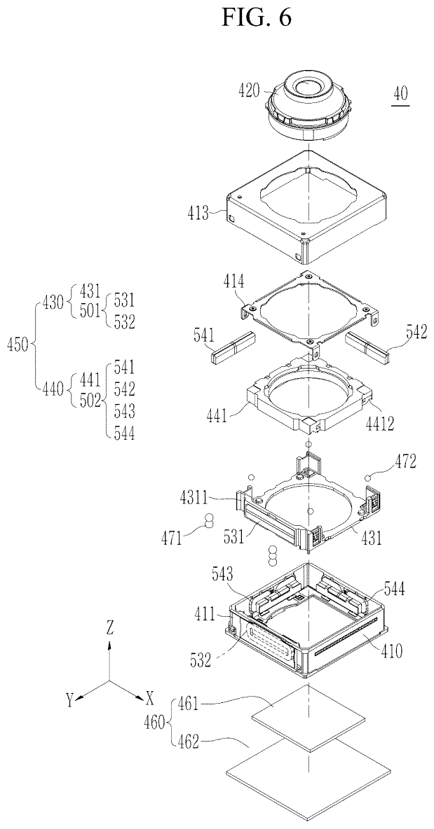

Hereinafter, an example camera module, in accordance with one or more embodiments, will be described with reference to FIG. 6. FIG. 6 illustrates an exploded perspective view schematically showing the example camera module, in accordance with one or more embodiments.

Referring to FIG. 6, the camera module 40, in accordance with one or more embodiments, may include a lens barrel 420, a lens driving device 450 that moves the lens barrel 420, an image sensor unit (or an image sensor portion) 460 that converts light incident through the lens barrel 420 to an electrical signal, a housing 410 that accommodates the lens barrel 420 and the lens driving device 450, and a cover 413.

A camera actuator, in accordance with one or more embodiments, may include a first carrier 431 configured to move in the optical axis direction, a second carrier 441 disposed on the first carrier 431 and configured to move in the direction perpendicular to the optical axis direction, a damper 601 protruding from a first surface of the first carrier 431 facing the second carrier 441 and configured to move in the direction perpendicular to the optical axis direction, and a stopper 602 that is disposed at one surface of the second carrier 441 to face the damper 601 in the direction perpendicular to the optical axis direction and is configured to limit movement of the second carrier 441 in the direction perpendicular to the optical axis direction.

The lens driving device 450 may be a device that moves the lens barrel 420, and may include a focus adjustment unit (or a focus adjustment portion) 430 that adjusts focus and a shaking correction unit (or a shaking correction portion) 440 that corrects shaking.

The lens barrel 420 may be fixed and accommodated in the second carrier 441 to be accommodated in the focus adjustment portion 430.

The focus adjustment portion 430 may include the first carrier 431 that accommodates the lens barrel 420 and a first lens driving portion 501 that generates a driving force to move the lens barrel 420 and the first carrier 431 in the optical axis direction.

The first lens driving portion 501 may include a first magnet 531 and a first coil 532. The first magnet 531 of the first lens driving portion 501 may be disposed to be mounted on one surface of the first carrier 431, and the first coil 532 may be disposed within a substrate (or a board) 411 to face the first magnet 531 so that it is mounted at the housing 410.

The first magnet 531 and the first coil 532 may provide a driving force to the first carrier 431. When electrical power is applied to the first coil 532, the first carrier 431 may be moved in the optical axis direction by the electromagnetic influence between the first magnet 531 and the first coil 532. Since the lens barrel 420 is accommodated in the first carrier 431, the lens barrel 420 may also move in the optical axis direction based on a movement of the first carrier 431.

When the first carrier 431 is moved, a plurality of first rolling members 471 may be disposed between the first carrier 431 and the housing 410 to reduce friction between the first carrier 431 and the housing 410. The plurality of first rolling members 471 may have a ball shape, and may be disposed at both sides of the first magnet 531. The first carrier 431 may have a plurality of first guide grooves 4311 on one surface thereof. The plurality of first rolling members 471 may be respectively disposed in the plurality of first guide grooves 4311. The plurality of first rolling members 471 may be accommodated in the plurality of first guide grooves 4311 to be guided in the optical axis direction. In other words, the plurality of first rolling members 471 may be configured to move the first carrier 431 in the optical axis direction.

The shaking correction portion 440 may include the second carrier 441 disposed on the first carrier 431 and guiding movement of the lens barrel 420 and a second lens driving portion 502 that generates a driving force to move the second carrier 441 in the direction perpendicular to the optical axis direction.

The second carrier 441 may be inserted into the first carrier 431 to be disposed in the optical axis direction, and may guide the movement of the lens barrel 420.

In an example, the second carrier 441 may have an approximately quadrangle frame shape. Second magnets 541 and 542 that provide a driving force to the second carrier 441 may be disposed above or on the second carrier 441. Specifically, the plurality of second magnets 541 and 542 may be disposed on two adjacent surfaces of the second carrier 441. A cover member 414 may be further disposed at an upper portion of the lens barrel 420 to prevent the second carrier 441 from being separated from an internal space of the first carrier 431. The cover member 414 may be coupled to the first carrier 431.

The second lens driving portion 502 may include the second magnets 541 and 542 and second coils 543 and 544. The plurality of second magnets 541 and 542 of the second lens driving portion 502 may be mounted on the second carrier 441. The plurality of second coils 543 and 544 may be disposed at the substrate 411 to respectively face the plurality of second magnets 541 and 542 so that they are fixedly mounted on the housing 410.

A plurality of second rolling members 472 may be provided to support the shaking correction portion 440, and the plurality of second rolling members 472 may operate to guide the second carrier 441 during the shaking correction process. In an example, the plurality of second rolling members 472 may be disposed at a plurality of guide grooves disposed on one surface of the second carrier 441 to move the second carrier 441 in the X-axis direction and the Y-axis direction.

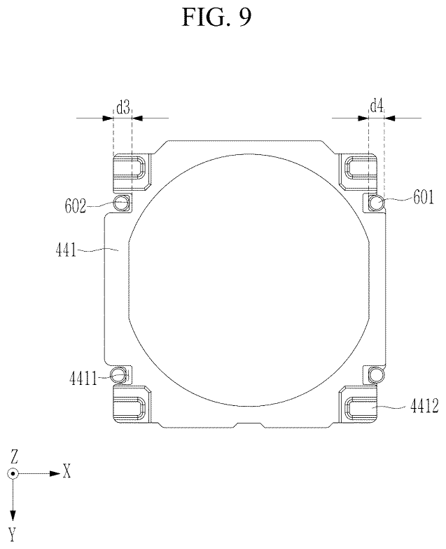

As a specific example, the second carrier 441 may have a plurality of second guide grooves 4412 as illustrated in FIGS. 6 and 9, or on a third surface facing the first carrier 431 in the optical axis direction. The plurality of second rolling members 472 may be respectively disposed in the plurality of second guide grooves 4412. The plurality of second rolling members 472 may be configured to move the second carrier 441 in the direction perpendicular to the optical axis direction. For example, the plurality of second rolling members 472 may be configured to move the second carrier 441 in the X-axis direction and the Y-axis direction.

Additionally, the plurality of second rolling members 472 may also operate to maintain an interval between the first carrier 431 and the second carrier 441. The plurality of second rolling members 472 may be disposed between the first carrier 431 and the second carrier 441.

The image sensor portion 460 is a device that converts light incident through the lens barrel 420 to the electrical signal. In an example, the image sensor portion 460 may include an image sensor 461 and a printed circuit board 462 connected to the image sensor 461, and may further include an infrared filter. The infrared filter may block light in an infrared region among light incident through the lens barrel 420.

The image sensor 461 may convert light incident through the lens barrel 420 to an electrical signal. In an example, the image sensor 461 may be a charge-coupled device (CCD) or a complementary metal-oxide semiconductor (CMOS). The electrical signal converted by the image sensor 461 may be output as an image through the display device of the portable electronic device. The image sensor 461 may be fixed to the printed circuit board 462, and may be electrically connected to the printed circuit board 462.

The lens barrel 420 and the lens driving device 450 may be accommodated in an inner space of the housing 410, and in a non-limited example, the housing 410 may have a box shape in which upper and lower portions are opened. The image sensor portion 460 may be disposed at a lower portion of the housing 410.

The cover 413 may be coupled to the housing 410 to cover an outer surface of the housing 410, and may operate to protect an internal part of the camera module. Additionally, the cover 413 may shield electromagnetic waves. For example, the cover 413 may shield the electromagnetic waves so that the electromagnetic waves generated in the camera module do not affect electronic components within the portable electronic device.

Additionally, since various electronic components other than the camera module may be mounted at the portable electronic device, the cover 413 may shield the electromagnetic waves so that the electromagnetic waves generated in the electronic components do not affect the camera module. The cover 413 may be made of a metal material to be grounded to a ground pad provided at the printed circuit board 462 so that the electromagnetic waves are shielded.

The first coil 532 of the first lens driving portion 501 and the plurality of second coils 543 and 544 of the second lens driving portion 502 may be buried or disposed within the substrate 411 so that the first coil 532 of the first lens driving portion 501 and the plurality of second coils 543 and 544 of the second lens driving portion 502 are formed as their own components of the substrate 411. Additionally, the first coil 532 of the first lens driving portion 501 and the plurality of second coils 543 and 544 of the second lens driving portion 502 may be buried or disposed together within one substrate 411.

Additionally, each of the first lens driving portion 501 and the second lens driving portion 502 may further include a sensing portion that senses (or detects) movement of the lens barrel 420, and the sensing portions of the first lens driving portion 501 and the second lens driving portion 502 may have an IC package form that may be controlled by a control unit (or a control portion) included in the printed circuit board 462 connected to the image sensor 461.

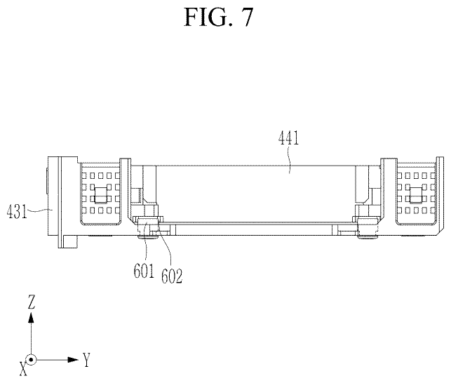

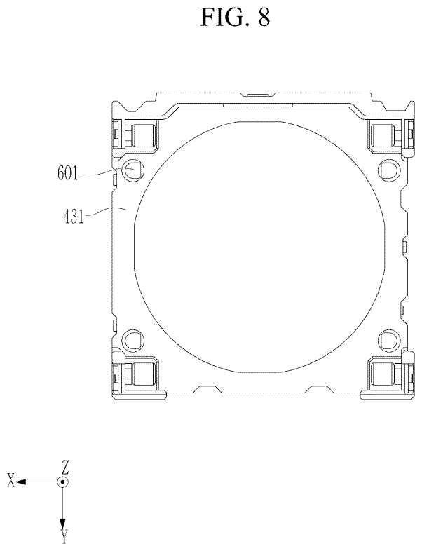

Hereinafter, the first carrier 431, the second carrier 441, the damper 601, and the stopper 602 will be described in more detail with reference to FIGS. 7 to 9. FIG. 7 is a plan view illustrating the first carrier, the second carrier, and the damper, FIG. 8 is a plan view of the first carrier and the damper according to an embodiment, and FIG. 9 is a plan view of the second carrier and the damper according to an embodiment. FIG. 8 is a plan view illustrating an inner bottom surface of the first carrier 431 at which the damper 601 is disposed, and FIG. 9 is a plan view illustrating a bottom surface of the second carrier 441 at which the damper 601 is disposed to show a relationship between the second carrier 441 and the damper 601.

Referring to FIG. 7 and FIG. 8, the damper 601 may be disposed on one surface of the first carrier 431. The damper 601 may be disposed between the first carrier 431 and the second carrier 441. The damper 601 may protrude in the optical axis direction from the first surface of the first carrier 431 facing the second carrier 441. Accordingly, when the first carrier 431 is moved in the direction perpendicular to the optical axis direction, an impact or a noise between the first carrier 431 and the second carrier 441 may be reduced.

The damper 601 may be provided in plural numbers. The damper 601 may be disposed at a corner region (or corner regions) of the first carrier 431. For example, if the first surface of the first carrier 431 has an approximately quadrangle shape, the plurality of dampers 601 may be disposed at four corner regions of the first carrier 431, respectively. The damper 601 may have a shape such as an approximately circular pillar or an approximately polygonal pillar.

The first carrier 431 may have a second surface facing the first surface in the optical axis direction. The damper 601 may penetrate the second surface from the first surface to protrude from the second surface in the optical axis direction. The damper 601 may penetrate a portion of the first carrier 431 to extend from the first surface to the second surface. The first carrier 431 may have a through hole that is penetrated by the damper 601. A portion of the damper 601 may be disposed between the first carrier 431 and the housing 410. Accordingly, when the first carrier 431 is moved in the optical axis direction, an impact or a noise between the first carrier 431 and the housing 410 may be reduced.

The damper 601 may be made of a material that may be elastically deformed by an external force, and may absorb an impact or may reduce an impact force by being deformed when it hits another structure. In a non-limited example, the damper 601 may be made of a material such as, but not limited to, rubber, urethane, silicone, or the like.

Referring to FIG. 7 and FIG. 9, a groove portion 4411 that is disposed at an edge of the second carrier 441 and accommodates the damper 601, may be disposed. The groove portion 4411 may extend inward from an outer edge of the second carrier 441. The groove portion 4411 may extend from one surface of the second carrier 441 facing the first carrier 431 in the optical axis direction. The groove portion 4411 may be provided in plural numbers.

A length of the damper 601 protruding from the first surface in the optical axis direction may be less than a length of the groove portion 4411 along the optical axis direction. Therefore, even when the damper 601 is accommodated in the groove portion, the damper 601 may be moved along the direction perpendicular to the optical axis.

The stopper 602 may be disposed on the one surface of the second carrier 441 so as to face the damper 601 in the direction perpendicular to the optical axis direction. The stopper 602 may be configured to limit the movement of the second carrier 441 in the direction perpendicular to the optical axis direction. The stopper 602 may include one surface of the edge of the second carrier 441 constituting the groove portion 4411. The stopper 602 may be disposed to surround at least a portion of the damper 601. Accordingly, when the first carrier 431 is moved in the example of the shaking correction or the like, a movement range of the damper 601 accommodated in the groove portion 4411 may be limited by the stopper 602. For example, when the first carrier 431 and the damper 601 are moved in the X-axis direction, the damper 601 may contact the stopper 602, and the movement range of the damper 601 may be limited.

The stopper 602 may be provided in plural numbers. The stopper 602 may be disposed at a corner region (or corner regions) of the second carrier 441. For example, if a plane perpendicular to the optical axis direction of the second carrier 441 has an approximately quadrangle shape, a plurality of stoppers 602 may be disposed at four corner regions of the second carrier 441, respectively.

The stopper 602 may have a quadrangle cross-sectional shape with a straight line or one edge open. The stopper 602 may have a shape complementary to a shape of an edge of the damper 601 facing the stopper 602. For example, the edge of the damper 601 facing the stopper 602 may have a straight-line shape, and an edge of the stopper 602 facing the damper 601 may have a straight-line shape that is complementary to a shape of the damper 601. However, the one or more examples are not limited thereto, and the edge of the stopper 602 facing the damper 601 may have any shape that may be complementarily coupled to a shape of the damper 601. Accordingly, when the damper 601 moves in the direction perpendicular to the optical axis direction, the damper 601 may be in contact with one edge of the stopper 602 so that a target movement range of the damper 601 may be more accurately implemented during the shaking correction.

A width of the groove portion 4411 along the direction perpendicular to the optical axis direction may be greater than a width of the damper 601 along the direction perpendicular to the optical axis direction. For example, a width d3 of the groove portion 4411 along the X-axis direction may be larger than a width d4 of the damper 601 along the X-axis direction. Specifically, a minimum width of the groove portion 4411 along the X-axis direction may be larger than the width d4 of the damper 601 along the X-axis direction, so that the damper 601 may be disposed to be spaced apart from the stopper 602. Therefore, when the damper 601 is accommodated in the groove portion 4411 to be moved in the direction perpendicular to the optical axis direction, the damper 601 may be moved within a difference range between the width of the groove portion 4411 along the direction perpendicular to the optical axis direction and the width of the damper 601 along the direction perpendicular to the optical axis direction.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera actuator, comprising:
a first carrier configured to move in an optical axis direction;
a second carrier, disposed on the first carrier, and configured to move in a direction perpendicular to the optical axis direction;
a damper that protrudes from a first surface of the first carrier that faces the second carrier; and
a stopper that is disposed on a first surface of the second carrier to face the damper in the direction perpendicular to the optical axis direction, and configured to limit a movement of the second carrier in the direction perpendicular to the optical axis direction.

2. The actuator of claim 1, wherein a groove portion is disposed at an edge of the second carrier, and the groove portion is configured to accommodate the damper.

3. The actuator of claim 2, wherein the stopper includes one surface of an edge of the second carrier constituting the groove portion.

4. The actuator of claim 2, wherein the stopper is configured to have a shape that is complementary to a shape of an edge of the damper facing the stopper.

5. The actuator of claim 2, wherein a width of the groove portion along the direction perpendicular to the optical axis direction is greater than a width of the damper along the direction perpendicular to the optical axis direction.

6. The actuator of claim 1, wherein the first carrier has a second surface that faces the first surface of the first carrier in the optical axis direction, and the damper is configured to penetrate the second surface of the first carrier from the first surface of the first carrier to protrude from the second surface of the first carrier.

7. The actuator of claim 1, wherein the damper is disposed at one or more corner regions of the first carrier.

8. The actuator of claim 1, wherein the stopper is disposed at one or more corner regions of the second carrier.

9. The actuator of claim 1, wherein each of the damper and the stopper is provided in plural numbers.

10. The actuator of claim 1, further comprising a lens holder that accommodates a lens barrel,
wherein the lens holder is disposed on the second carrier.

11. The actuator of claim 1, wherein the first carrier has a plurality of first guide grooves on a side surface thereof, the second carrier has a plurality of second guide grooves on a third surface of the second carrier facing the first carrier, and the actuator further includes a plurality of first rolling members respectively disposed in the plurality of first guide grooves and configured to move the first carrier in the optical axis direction, and a plurality of second rolling members respectively disposed in the plurality of second guide grooves and configured to move the second carrier in the direction perpendicular to the optical axis direction.

12. The actuator of claim 11, wherein the second carrier has a plurality of third guide grooves on a fourth surface of the second carrier that faces the third surface of the second carrier in the optical axis direction, and the actuator further includes a plurality of third rolling members respectively disposed in the plurality of third guide grooves, and configured to move the second carrier in the direction perpendicular to the optical axis direction.

13. The actuator of claim 1, further comprising:
a magnet disposed on a side surface of the first carrier and configured to provide a driving force to the first carrier; and
a coil disposed to face the magnet, and configured to provide a driving force to the first carrier.

14. A camera module, comprising:
a lens barrel;
a housing that accommodates the lens barrel;
a first carrier configured to move in an optical axis direction;
a second carrier, disposed on the first carrier, and configured to move in a direction perpendicular to the optical axis direction;
a damper that protrudes from a first surface of the first carrier that faces the second carrier; and
a stopper that is disposed on a first surface of the second carrier to face the damper in the direction perpendicular to the optical axis direction, and configured to limit a movement of the second carrier in the direction perpendicular to the optical axis direction.

15. The camera module of claim 14, wherein a groove portion is disposed at an edge of the second carrier and the groove portion is configured to accommodate the damper.

16. The camera module of claim 15, wherein the stopper includes one surface of an edge of the second carrier constituting the groove portion.

17. The camera module of claim 15, wherein a width of the groove portion along the direction perpendicular to the optical axis direction is greater than a width of the damper along the direction perpendicular to the optical axis direction.

18. The camera module of claim 14, wherein the first carrier has a second surface that faces the first surface of the first carrier in the optical axis direction, and the damper is configured to penetrate the second surface of the first carrier from the first surface of the first carrier to protrude from the second surface of the first carrier.

19. The camera module of claim 14, wherein the first carrier has a plurality of first guide grooves on a side surface thereof, the second carrier has a plurality of second guide grooves on a third surface of the second carrier facing the first carrier, and the camera module further includes a plurality of first rolling members respectively disposed in the plurality of first guide grooves and configured to move the first carrier in the optical axis direction, and a plurality of second rolling members respectively disposed in the plurality of second guide grooves and configured to move the second carrier in the direction perpendicular to the optical axis direction.

20. The camera module of claim 19, wherein the second carrier has a plurality of third guide grooves on a fourth surface of the second carrier that faces the third surface of the second carrier in the optical axis direction, and the camera module further includes a plurality of third rolling members respectively disposed in the plurality of third guide grooves and configured to move the second carrier in the direction perpendicular to the optical axis direction.
